(19) United States
(12) Patent Application Publication
(10) Pub. No.: US 2021/0193359 A1
(43) Pub. Date: Jun. 24, 2021

(54) TYPE OF ELECTROMAGNET USED FOR VARIOUS APPLICATIONS

(71) Applicant: BILAL MUHAMMAD IBN SABIR, DECATUR, GA (US)

(72) Inventor: BILAL MUHAMMAD IBN SABIR, DECATUR, GA (US)

(21) Appl. No.: 16/720,440

(22) Filed: Dec. 19, 2019

(51) Int. Cl. H01F 7/20; H02K 1/26; H02K 3/12

(52) U.S. Cl. CPC H01F 7/20; H02K 3/12; H02K 1/26

(57) ABSTRACT

An electromagnet comprising of a spiral form of an electrically conductive material within a spiral form of a material having a high magnetic permeability. In addition, variations of the spiral forms produce intricate electromagnet shapes and assemblies, such assemblies form differing magnetic fields, also simplifying manufacturing time, cost, and offer a quicker assembly process and integration construction.

### CROSS-REFERENCE TO RELATED APPLICATIONS

The present application is a non-provisional patent application which claims priority to U.S. provisional patent applications, U.S. Provisional Application. No. 62/786,442, filed on Dec. 30, 2018, U.S. Provisional Application. No. 62/786,441, filed on Dec. 30, 2018, U.S. Provisional Application. No. 62/786,433, filed on Dec. 29, 2018, U.S. Provisional Application. No. 62/786,449, filed on Dec. 30, 2018, U.S. Provisional Application. No. 62/786,443, filed on Dec. 30, 2018, U.S. Provisional Application. No. 62/786,430, filed on Dec. 29, 2018, U.S. Provisional Application. No. 62/786,448, filed on Dec. 30, 2018, disclosures of which are incorporated herein at least by reference.

### BACKGROUND OF THE INVENTION

### 1. Field of the Invention

The present invention is in the field of electromagnets and electromagnet devices.

### 2. Discussion of the State of the Art

In the field of electromagnets, electromagnets have gone fairly unchanged since their inception, most electromagnets rely upon taking a copper wire and winding it around a steel core.

One problem with traditional electromagnets are they are very difficult to manufacture and require such incredible amounts of time to produce as they require a piece of machinery which literally must spin repeatedly to wind a copper wire around a steel core.

Another limitation is the designs and shapes of which an electromagnet can be produced in, due to the lack of innovation and the limited method of making such an electromagnet, this hinders the ability to use electromagnets in a wider range in far more advanced electromagnet devices and applications.

FIG. 1 shows a prior art electromagnet 100, with a copper wire coil 101, wrapped around an iron steel core 102.

Therefore, what is clearly needed is an electromagnet and a method for making such an electromagnet that solves the problems mentioned above.

### SUMMARY OF THE INVENTION

In one embodiment of the present invention, combines a spiral form of an electrically conductive material (e.g. copper, silver, aluminum, etc.), within a spiral form of a material having a high magnetic permeability (e.g. electrical steel, iron, nickel-iron alloy, etc.) thus resulting in an electromagnet that offers a broader application range in far more advanced electromagnet devices than that of traditional electromagnets.

Furthermore, it provides a simpler manufacturing method of making such an electromagnet by the use of a stamping press (in addition, to other manufacturing and production methods, e.g. laser cutting, water jet cutting, wire EDM, injection molding etc.) allowing for the electromagnets to be manufactured faster, quicker and offer a larger variety spectrum of intricate designs and electromagnet configurations.

In at least one embodiment of the present invention, it combines a multi-layer electromagnet with a LC circuit for use as a transceiver.

In at least one embodiment of the present invention, it combines an electromagnet with an aluminum disc form which is then used as an electromagnet vibration device.

In at least one embodiment of the present invention, it combines an array of multi-layer electromagnets which surround an aluminum rotor which is then is used as an electric motor.

In at least one embodiment of the present invention, it combines a multi-layer electromagnet within a multi-layer electromagnet which is then used as a transformer.

In at least one embodiment of the present invention, it combines a multi-layer electromagnet within an aluminum structural support base, along with an electromagnet vibration device which is then used as an electromagnet levitation device.

In at least one embodiment of the present invention, it combines a multi-layer electromagnet within an aluminum enclosure, and an aluminum enclosure head and an aluminum shaft, along with an electromagnet vibration device which is then used as an electromagnet propulsion device.

In at least one embodiment of the present invention, it combines an electromagnet with having a permanent magnet placed within its center which is then used as an electromagnet speaker.

A further understanding of the nature and advantages of the present invention may be realized by reference to the remaining portions of the detailed description and the drawings.

### BRIEF DESCRIPTION OF THE DRAWINGS

FIG. 1 is a perspective view showing a prior art electromagnet.

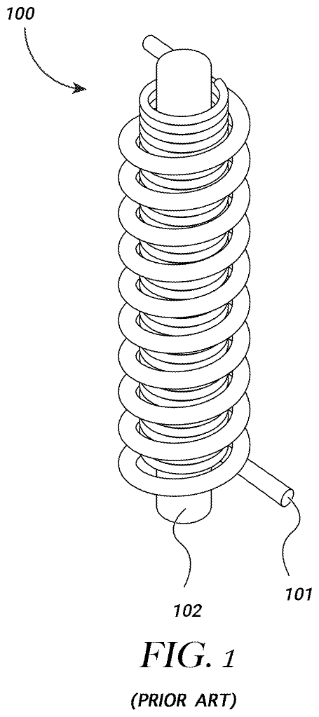

FIG. 2 is a perspective view of an electromagnet according to a preferred embodiment of the present invention.

FIG. 3 is a top view of an electromagnet, also including two individual spiral forms according to one embodiment of the present invention.

FIG. 4 is a perspective view of an electromagnet assembly method according to one embodiment of the present invention.

FIG. 5 is a perspective view of nine multi-layer electromagnet shapes according to nine embodiments of the present invention.

FIG. 6 is a perspective view of fourteen electromagnet shapes according to fourteen embodiments of the present invention.

FIG. 7 is an exploded perspective view of an electromagnet vibration device according to one embodiment of the present invention.

FIG. 8 is a perspective section view of a multi-layer electromagnet sphere used as a transceiver according to one embodiment of the present invention.

FIG. 9 is a communication transmission network diagram according to one embodiment of the present invention.

FIG. 10 is a perspective view of an assembly method of a multi-layer electromagnet according to one embodiment of the present invention.

FIG. 11 is a perspective partial view of an array of multi-layer electromagnets surrounding an aluminum rotor which is then used as an electric motor according to one embodiment of the present invention.

FIG. 12 is an AC delta wiring diagram of an electric motor according to one embodiment of the present invention.

FIG. 13 is an exploded perspective view of a multi-layer electromagnet cube within a multi-layer electromagnet cube, and also including an electromagnet vibration device which is then used as a transformer according to one embodiment of the present.

FIG. 14 is an exploded perspective view of a multi-layer electromagnet within an aluminum structural support base, and also including an electromagnet vibration device which is then used as an electromagnet levitation device according to one embodiment of the present invention.

FIG. 15 is an exploded perspective view of a multi-layer electromagnet within an aluminum enclosure, an aluminum shaft, aluminum enclosure head, along with an electromagnet vibration device which is then used as an electromagnet propulsion device according to one embodiment of the present invention.

FIG. 16 is a perspective view of an electromagnet having a permeant magnet placed within its center and used as an electromagnet speaker according to one embodiment of the present invention.

### DETAILED DESCRIPTION OF THE INVENTION

The present invention is described in enabling detail using following examples, which may describe more than one relevant embodiment falling within the scope of the present invention.

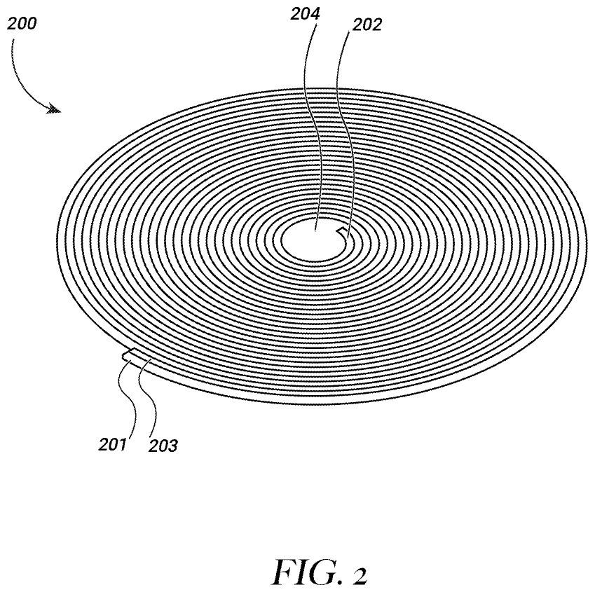

FIG. 2 is a perspective view of an electromagnet 200 according to a preferred embodiment of the present invention, an electromagnet 200 comprising a spiral form 201, and 202 being the same spiral form and made out of an electrically conductive material, as copper but not limited to, copper (e.g. silver, aluminum, gold, etc., or any electrically conductive material having the ability to produce a specific desired effect, etc.) such a spiral form is produced by the use of a stamping press but not limited to, a stamping press (e.g. CNC milling, waterjet, laser, wire EDM, injection molding, etc. or any machining or manufacturing technique or method which allows the ability to produce such a desired shape or form) which utilizes a roll of copper sheet metal but not limited, to a roll of copper sheet metal (e.g. silver, gold, aluminum, a copper sheet of sheet metal, a solid form of copper, a block of copper, or any electrically conductive material having the ability to produce a specific desired effect, etc.) which then punches out or stamps out the spiral form (201, 202), the spiral form (201,202) is then placed within a spiral form 203 and 204 being the same spiral form, and made out of a material having a high magnetic permeability as electrical steel, but not limited to, electrical steel (e.g. iron, nickel-alloy, alloy steel, or any material having a high magnetic permeability and the ability to produce a desired effect, etc.) such a spiral form (203, 204) is produced by the use of a stamping press but not limited to, a stamping press (e.g. CNC milling, waterjet, laser, wire EDM, injection molding, or any machining or manufacturing technique or method which allows the ability to produce such a desired shape or form, etc.) which utilizes a roll of electrical steel sheet metal but not limited, to a roll of electrical steel sheet metal (e.g. a sheet of electrical steel metal, a solid form of alloy steel metal, a block of alloy steel, iron, nickel-iron alloy, alloy steel, or any material having a high magnetic permeability and the ability to produce a specific desired effect, etc.) which then punches out or stamps out the spiral form (203, 204).

Additionally, spiral forms 201, 202, 203, 204 are electrically insulated with an electrical insulation coating, (e.g. epoxy coating, polyesterimide enamel, polyurethane enamel, polyimide enamel, resin, etc.).

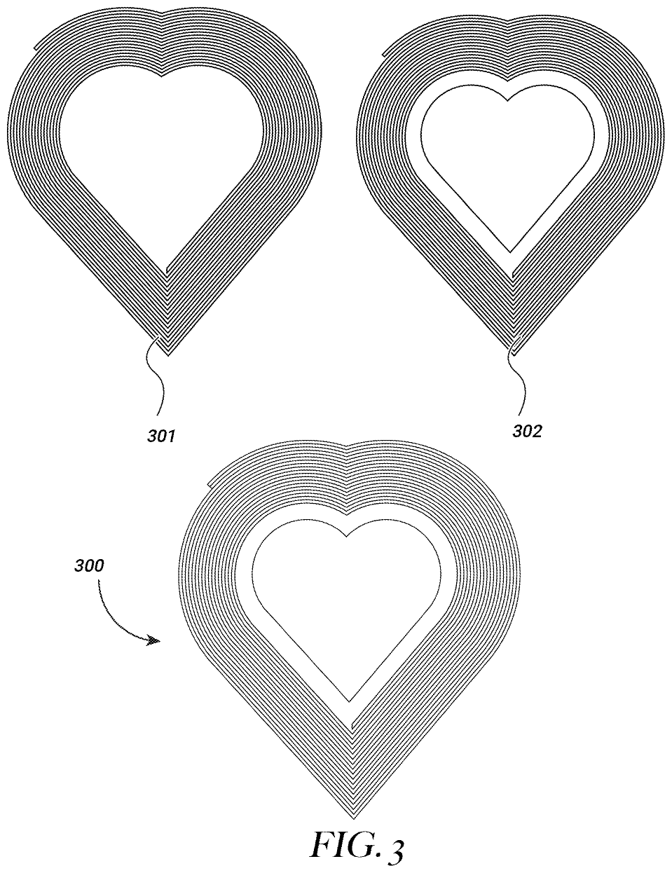

FIG. 3 is a top view of an electromagnet 300 according to one embodiment of the present invention in addition to an individual spiral form 301 made out of an electrically conductive material, as copper, but not limited to copper, (e.g. silver, aluminum, gold, or any electrically conductive material having the ability to produce a specific desired effect, etc.), such a spiral form 301 is produced by the use of a stamping press but not limited to, a stamping press (e.g. CNC milling, waterjet, laser, wire EDM, injection molding, or any machining or manufacturing technique or method which allows the ability to produce such a desired shape or form, etc.) which utilizes a roll of copper sheet metal but not limited, to a roll of copper sheet metal (e.g. silver, gold, aluminum, a copper sheet of sheet metal, a solid form of copper, a block of copper, or any electrically conductive material having the ability to produce a specific desired effect, etc.) which then punches out or stamps out the spiral form 301.

Also shown is an individual spiral form 302 which is a material of a high magnetic permeability made out of electrical steel, but not limited to electrical steel, (e.g. iron, nickel-alloy, alloy steel, or any material having a high magnetic permeability and ability to produce a desired effect, etc.) such a spiral form 302 is produced by the use of a stamping press but not limited to, a stamping press (e.g. CNC milling, waterjet, laser, wire EDM, injection molding, or any machining or manufacturing technique or method which allows the ability to produce such a desired shape or form) which utilizes a roll of electrical steel sheet metal but not limited, to a roll of electrical steel sheet metal (e.g. a sheet of electrical steel metal, a solid form of alloy steel metal, a block of alloy steel, iron, nickel-iron alloy, alloy steel, or any material having a high magnetic permeability and the ability to produce a specific desired effect, etc.) which then punches out or stamps out the spiral form 302, spiral form 302, is then placed within spiral form 301 forming an electromagnet 300 being one embodiment of the present invention.

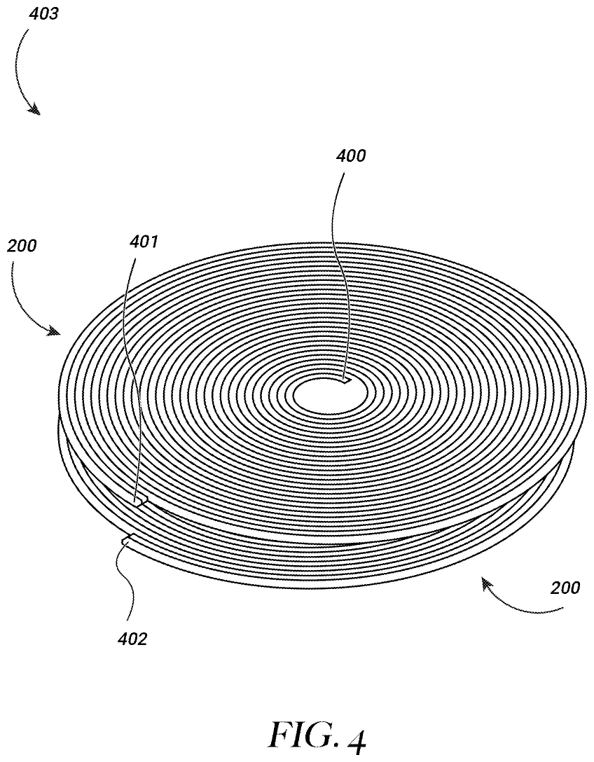

FIG. 4 is a perspective view of an electromagnet 200 showing one assembly method for a multi-layer electromagnet 403 according to one embodiment of the present invention.

When an electrical current is applied to a provisional area of spiral form 400 top side which is not electrically insulated, the electrical current begins traveling through the spiral form 400 and exits out of a provisional area on the underside of the spiral form 401 end point which is not electrically insulated (400, 401 is the same spiral form).

This electrical current then begins traveling and maintaining the same consistent electrical current direction and enters into a provisional area of spiral form 402 top side which is not electrically insulated. Thus, resulting in the top electromagnet 200 becoming electrically connected, with the bottom electromagnet 200 and now producing a multi-layer electromagnet 403.

Furthermore, top electromagnet 200 has been flipped and slightly rotated allowing for an electrical current to enter and then exit, and then enter into bottom electromagnet 200 while maintaining a consistent electrical current direction. This assembly method enables multiple electromagnets to be stacked and or assembled together to become a multi-layer electromagnet and is one embodiment of the present invention.

Additionally, the non-electrical insulated provisional areas which bond both electromagnet 200 together uses an electrically conductive adhesive but not limited to, an electrically conductive adhesive (e.g. solder, weld, or any manufacturing or production technique, or method which allowed two or more objects to be electrically connected, and bounded together while maintaining an electrical conductive flow of an electrical current, etc.).

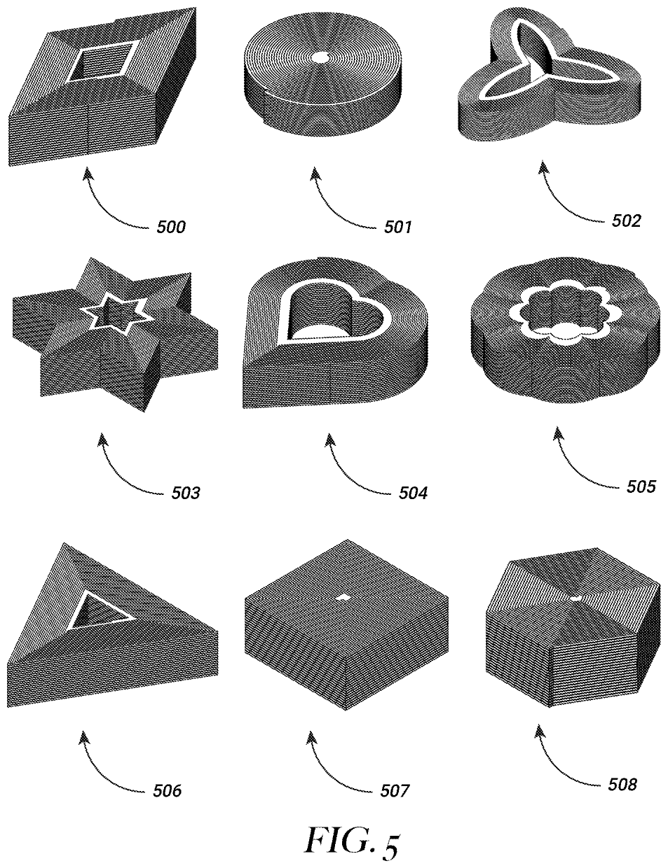

FIG. 5 is a perspective view showing nine multi-layer electromagnets of various shapes according to nine embodiments of the present invention, 500-508, are multi-layer electromagnets.

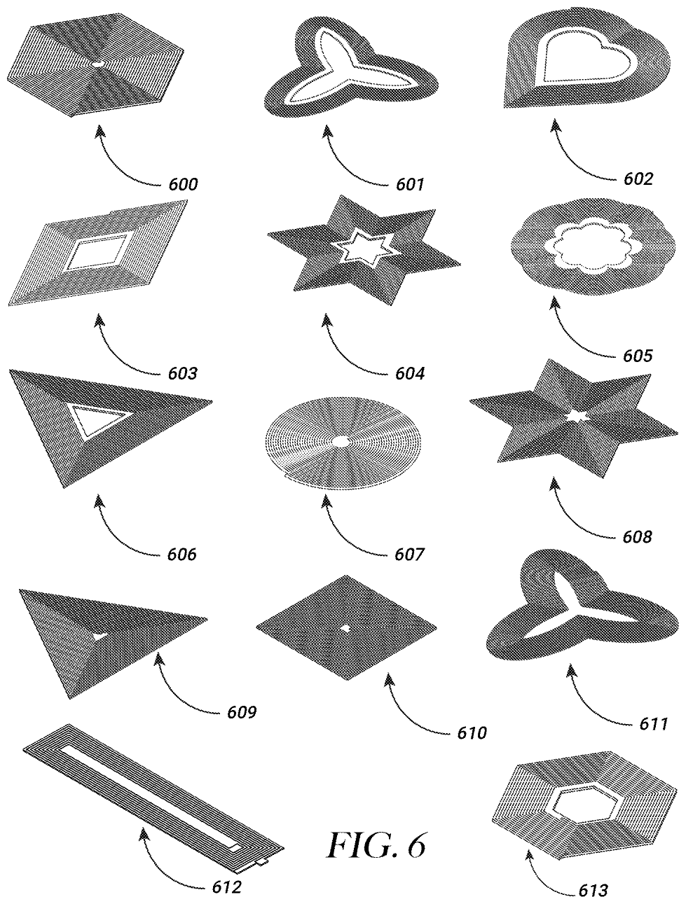

FIG. 6 is a perspective view showing fourteen electromagnet shapes according to fourteen embodiments of the present invention, 600-613 is an electromagnet.

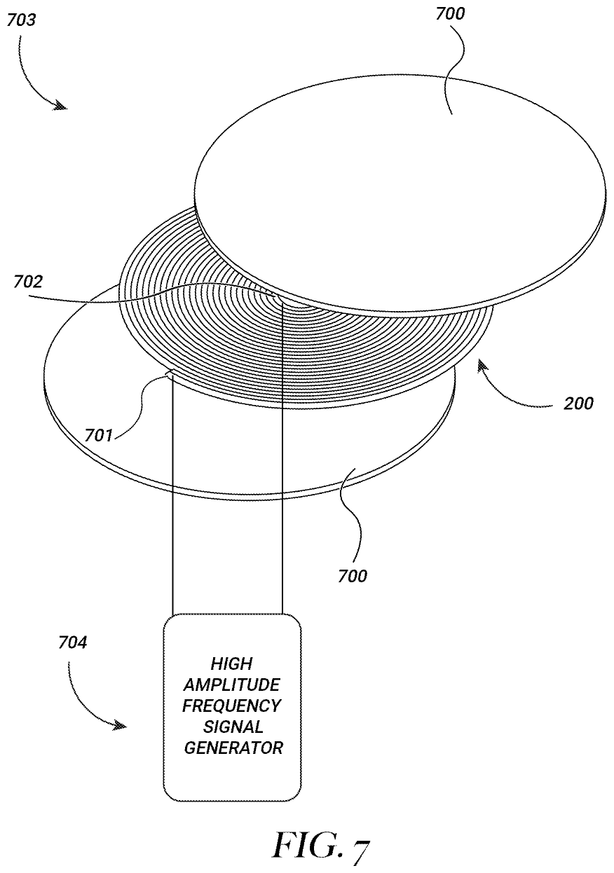

FIG. 7 is an exploded perspective view of an electromagnet vibration device 703, being one embodiment of the present invention, comprising two aluminum disc 700 placed on opposite sides of electromagnet 200, when a high amplitude frequency signal is applied to the electromagnet 200 from a high amplitude frequency signal generator 704, the electromagnet 200 begins vibrating between both aluminum disc 700, these electric magnetic vibrations began effecting the magnetic fields produced by an external electromagnet which the electromagnet vibration device 703 becomes placed up against, by altering, manipulating, and distorting the magnetic fields and magnetic field frequencies.

Furthermore, the input signal from the high amplitude frequency signal generator 704 is applied to a provisional area which is not electrically insulated on the spiral form 701, and 702 end points. The aluminum disc 700 being made out of 6061 aluminum alloy sheet metal but not limited to, 6061 aluminum alloy sheet metal (e.g. aluminum alloy 6063, aluminum alloy 7075, etc.) is produced by the use of a stamping press, but is not limited to, a stamping press (e.g. CNC milling, waterjet, laser, wire EDM, injection molding, or any machining or manufacturing technique or method which allows the ability to produce such a desired shape or form) which utilizes a roll of 6061 aluminum alloy sheet metal, but not limited, 6061 aluminum alloy sheet metal (e.g. aluminum alloy 6063, aluminum alloy 7075, etc.) which then punches out or stamps out the disc form.

Additionally, aluminum naturally produces and mimics electric magnetic fields thus enabling a vibration of electromagnet 200 between the aluminum disc 700 to occur.

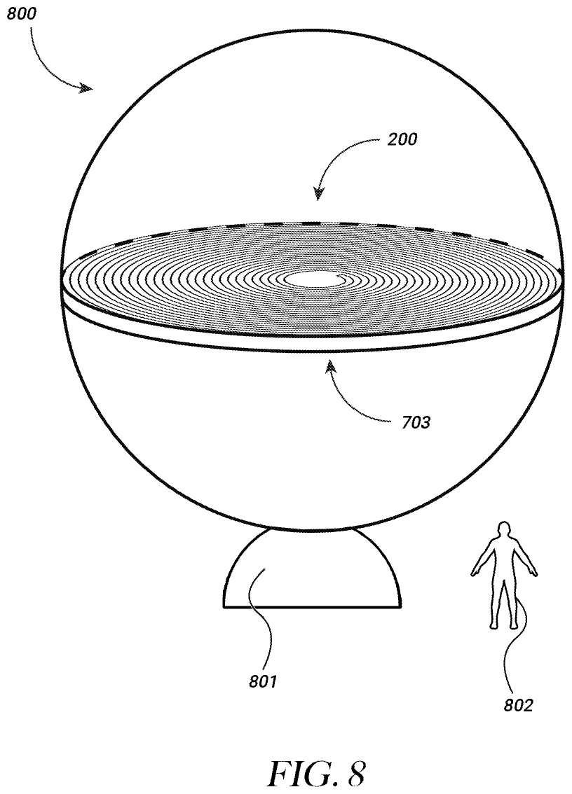

FIG. 8 is a perspective section view of a multi-layer electromagnet 800 sphere used as an electromagnet transceiver according to one embodiment of the present invention, which rest on a support base 801, and showing a section cut view of an electromagnet 200, which rest on an electromagnet vibration device 703 and a human scale comparison 802.

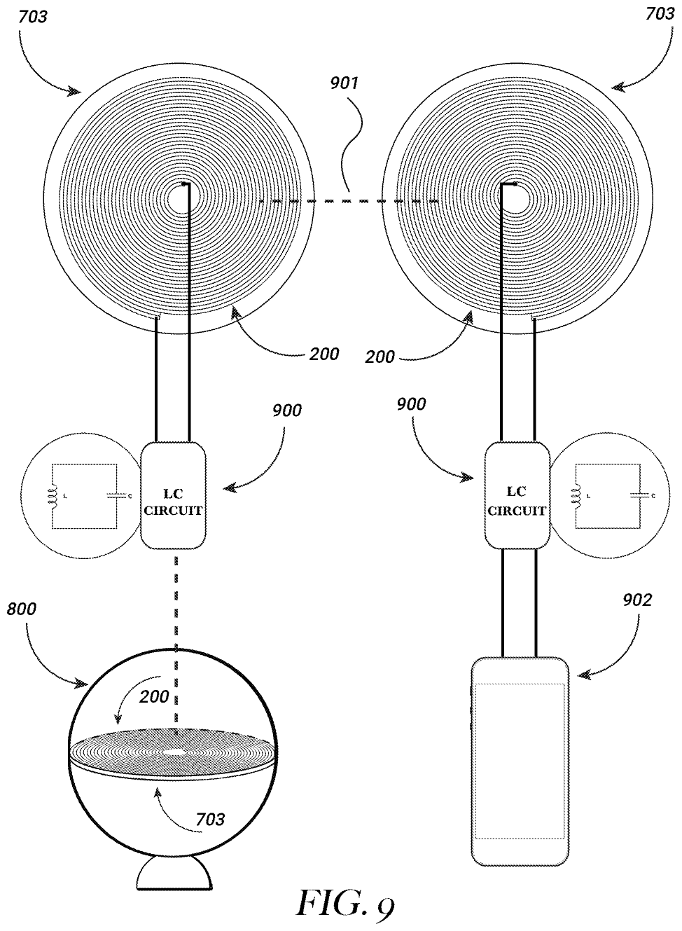

FIG. 9 is a signal broadcast network diagram according to one embodiment of the present invention, a magnetic field 901 is produced by a multi-layer electromagnet 800 sphere, which then becomes matched and paired with electromagnet 200 magnetic fields 901 of mobile device 902, by using a LC circuit 900, an electromagnet vibration device 703 then vibrates the magnetic fields 901 of the multi-layer electromagnet 800 sphere, in addition to the electromagnet 200 of the mobile device 902, which enables a broader frequency spectrum of the magnetic fields 901 for signal communication and transmission.

Additionally, a multi-layer electromagnet 800 sphere can be paired and matched to another multi-layer electromagnet 800 sphere or paired and matched with various other electronic devices (e.g. computers, tablets, smart electronics, tv's, among any other devices requiring communication and connectivity, etc.).

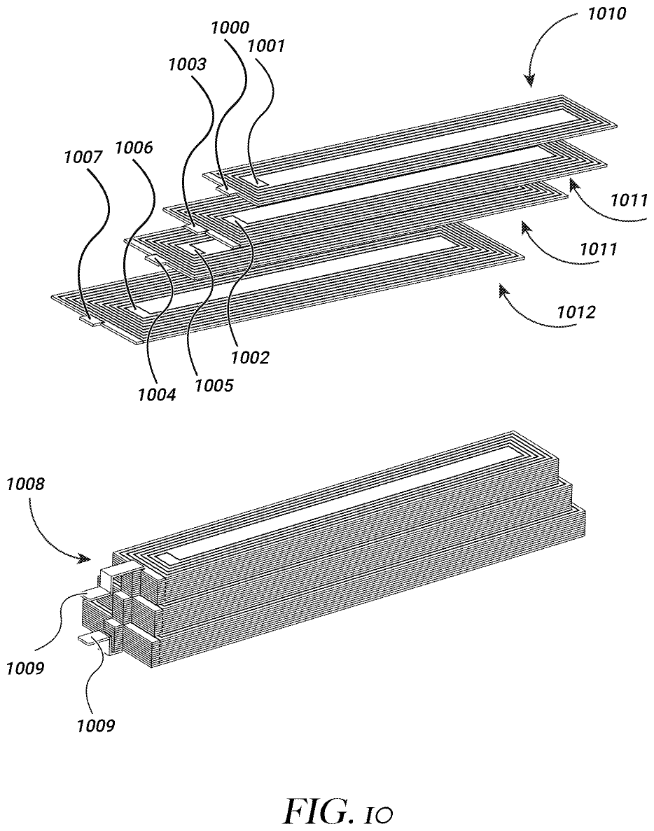

FIG. 10 is a perspective view of an assembly method of a multi-layer electromagnet 1008 according to one embodiment of the present invention, an electromagnet 1010 being of the smallest size, is placed on top of an electromagnet 1011 being of the middle size, which is placed on top of an electromagnet 1012 being of the largest size.

When an electrical current is applied to spiral form 1000 top side it then exits out the underside of spiral form 1001, and then enters into spiral form 1002 top side and then exits out the underside of spiral form 1003, and then enters into spiral form 1004 top side and then exits out the underside of spiral form 1005, and then enters into spiral form 1006 top side, and then exits out the underside of spiral form 1007. Thus, producing a multi-layer electromagnet 1008.

Additionally, provisional areas on the spiral forms 1000, 1001, 1002, 1003, 1004, 1005, 1006, 1007 end points are not electrically insulated thus allowing an electrical current to enter into one spiral form and then exiting out into another spiral form.

Furthermore, the second electromagnet 1011 from the top and the fourth electromagnet 1012 from the top have been flipped to allow a consistent flow of an electrical current to travel from one electromagnet into another electromagnet while maintaining the same consistent electrical current direction.

Lastly, spiral forms, 1000, 1001, 1002, 1003, 1004, 1005, 1006, 1007, along with the electrical connectors 1009 which provisional areas are not electrically insulated are bonded to their corresponding spiral forms using an electrically conductive adhesive, but not limited to, electrically conductive adhesive (e.g. solder, weld, etc.) according to one embodiment of the present.

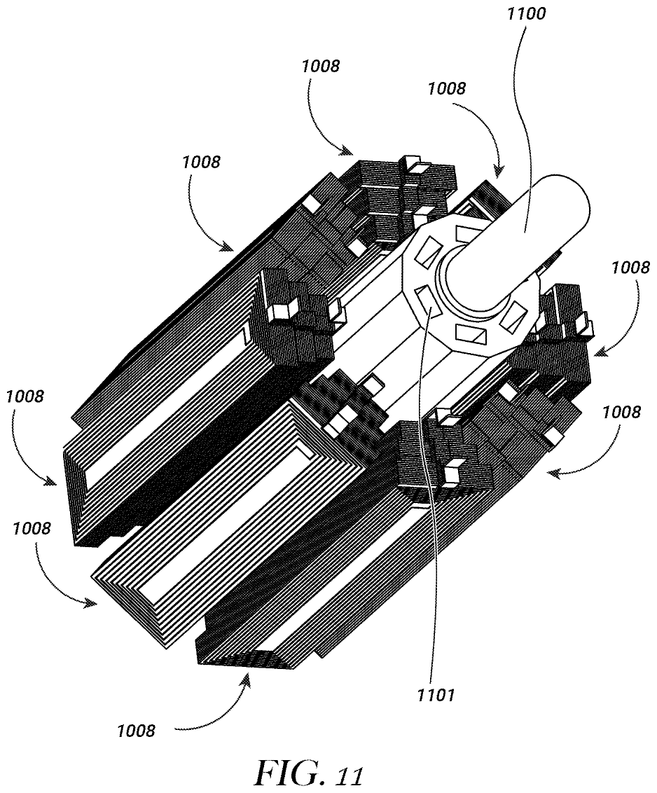

FIG. 11 is a perspective partial view of an array of multi-layer electromagnet 1008 according to one embodiment of the present invention, when an AC electrical current is applied to the array of multi-layer electromagnet 1008, they begin producing and inducing magnetic fields into an aluminum rotor 1100 which begins causing the aluminum rotor 1100 to spin and rotate, additionally permanent magnets are placed within the aluminum rotor 1100 slots 1101, which further aid with the spinning and rotating of the aluminum rotor 1100, such an aluminum rotor 1100 is made out of 6061 aluminum round bar, but not limited to, 6061 aluminum round (e.g. 6063 aluminum round bar, 7075 aluminum round bar, etc.) by machining the aluminum rotor 1100 with a CNC milling machine but not limited to, a CNC milling machine (e.g. wire EDM, waterjet, injection molding, or any machining or manufacturing technique or method which allows the ability to produce such a desired shape or form).

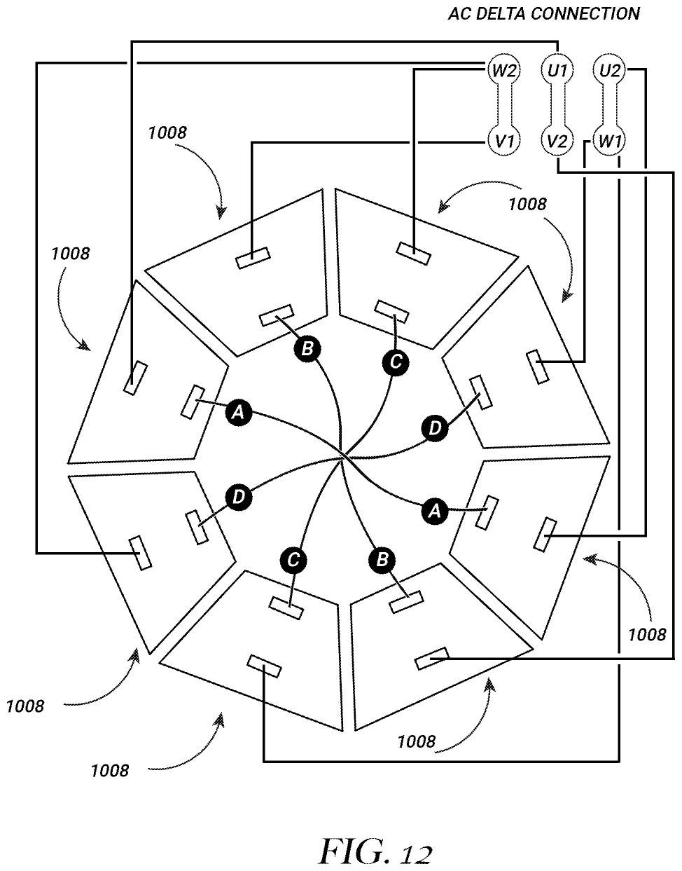

FIG. 12 is an AC delta wiring diagram for an electric motor according to one embodiment of the present invention, shown is an AC Delta wiring diagram, with each multi-layer electromagnet 1008 additionally, being matched by wire to their respective corresponding multi-layer electromagnet 1008, as indicated, A and A are linked together, B and B are linked together, C and C are linked together, D and D are linked together.

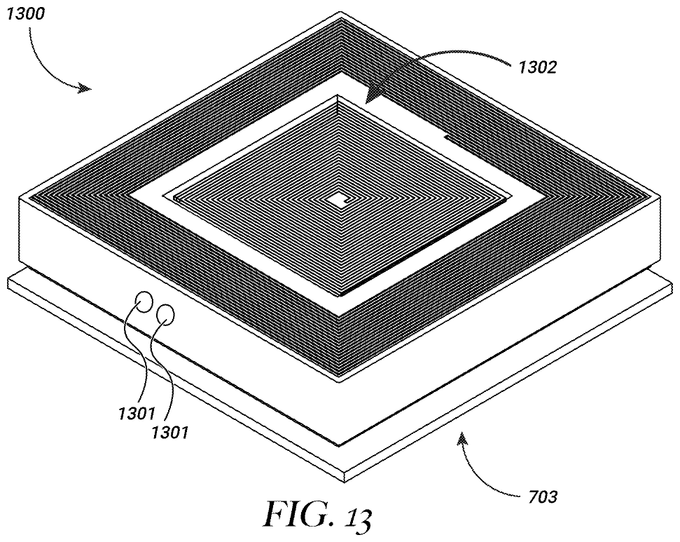

FIG. 13 is an exploded perspective view of a multi-layer electromagnet 1300 cube according to one embodiment of the present invention, when an AC electrical current is applied to the multi-layer electromagnet 1300 cube terminals 1301, the multi-layer electromagnet 1300 cube begins producing magnetic fields, these magnetic fields are then induced within a multi-layer electromagnet 1302 cube, showing up as an increase in electrical voltage as a step-up transformer being that the multi-layer electromagnet 1302 cube has more spiral turns than that of the multi-layer electromagnet 1300 cube, additionally when an electromagnet vibration device 703 is placed up against the multi-layer electromagnet 1300, and 1302 cube it begins vibrating the magnetic fields produced by the multi-layer electromagnet 1300, and 1302 cube, thus increasing the electrical current in the multi-layer electromagnet 1302 cube.

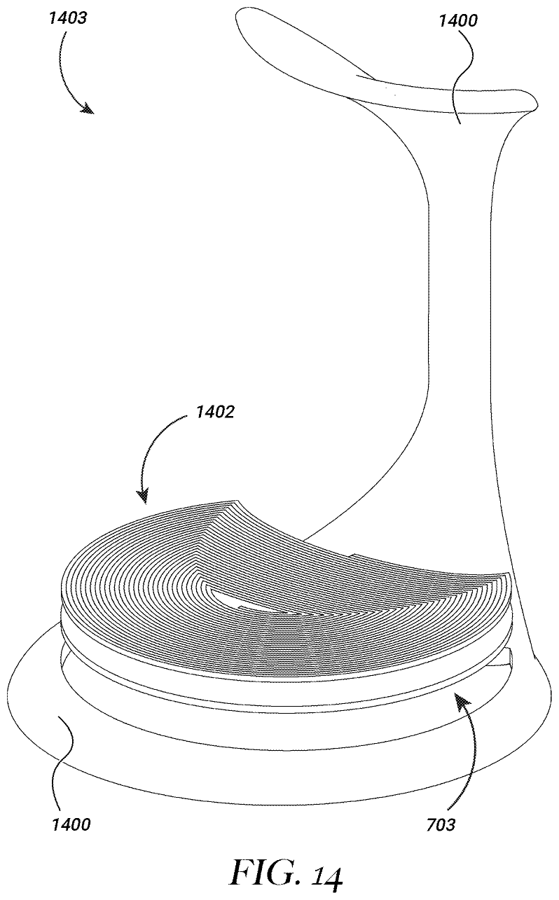

FIG. 14 is an exploded perspective view of an electromagnet levitation device 1403, according to one embodiment of the present invention. When an AC electrical current is applied to multi-layer electromagnet 1402 it begins producing magnetic fields these magnetic fields are then vibrated by an electromagnet vibration device 703 which begin causing the magnetic fields produced by the multi-layer electromagnet 1402 to produce an area of electric magnetic levitation, the aluminum structural support base 1400 helps to further aid and concentrate and focus the magnetic fields produced by the multi-layer electromagnet 1402.

Additionally, the aluminum structural support base 1400, is made from 6061 aluminum slab, but not limited to, 6061 aluminum slab (e.g. 6063 aluminum slab, 7075 aluminum slab, etc.) one such method for making such an aluminum structural support base 1400 is by the use of CNC milling, but not limited to CNC milling (e.g. waterjet, laser, wire EDM, injection molding, or any machining or manufacturing technique or method which allows the ability to produce such a desired shape or form, etc.).

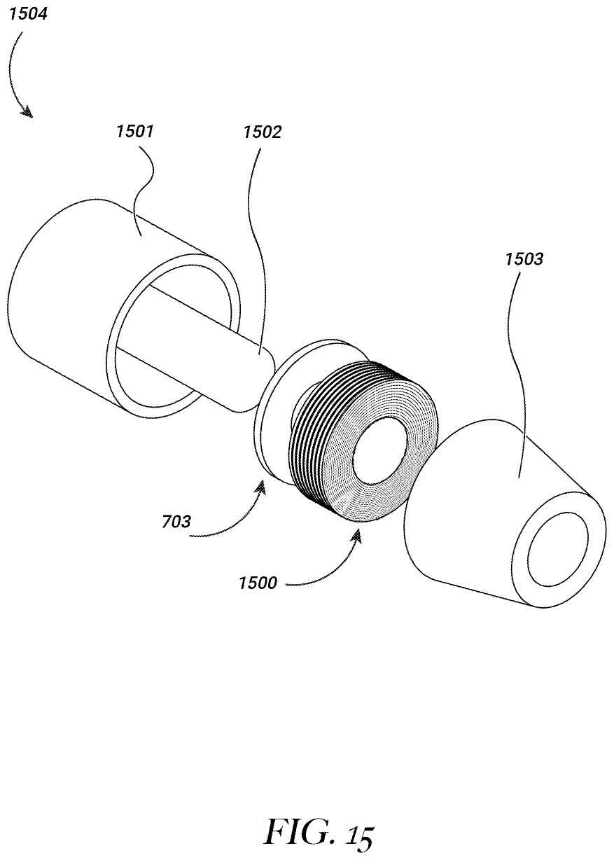

FIG. 15 is an exploded perspective view of an electromagnet propulsion device 1504, according to one embodiment of the present invention, when an AC electrical current is applied to the multi-layer electromagnet 1500, it begins producing magnetic fields, these magnetic fields are then vibrated by an electromagnet magnet vibration device 703, thus causing the magnetic fields frequency state to change, which suddenly causes a repulsive propulsion. The aluminum enclosure 1501, the aluminum shaft 1502, and the aluminum enclosure head 1503 is made from 6061 aluminum round bar, but not limited to 6061 aluminum round bar (e.g. 6063 aluminum round bar, 7075 aluminum round bar, etc.). Once such method for making such an aluminum enclosure 1501, and an aluminum shaft 1502, and an aluminum enclosure head 1503, is by the use of CNC milling, but not limited to CNC milling (e.g. waterjet, laser, wire EDM, injection molding, or any machining or manufacturing technique or method which allows the ability to produce such a desired shape or form).

Additionally, the aluminum enclosure 1501, the aluminum shaft 1502, and the aluminum enclosure head 1503, helps to support and concentrate the magnetic fields produced by the multi-layer electromagnet 1500.

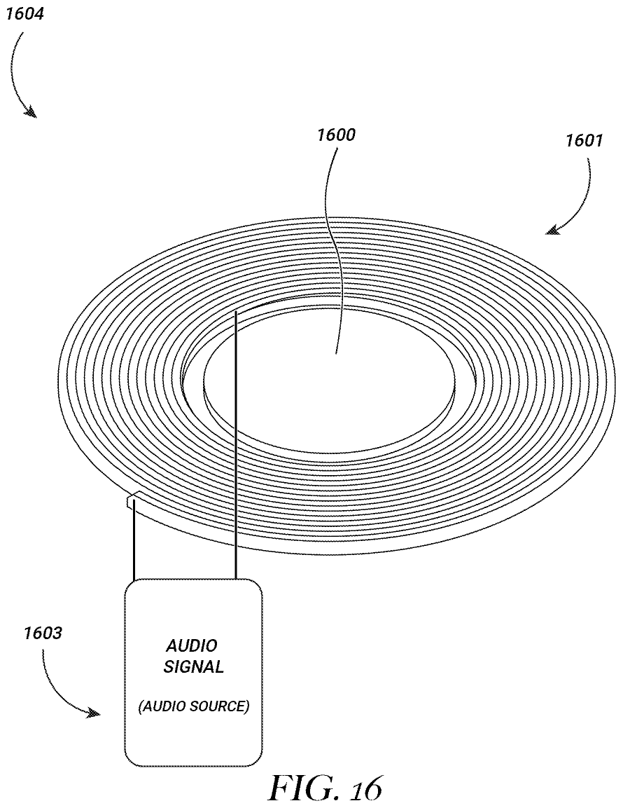

FIG. 16 is a perspective view of an electromagnet speaker 1604, according to one embodiment of the present invention. When an audio signal from audio source 1603 is applied to the electromagnet 1601 it begins producing magnetic fields, these magnetic fields are then induced into a permanent magnet 1600, which enables an audible audio to be heard.

What is claimed is:

1. An electromagnet comprising:
a spiral form of an electrically conductive material;
within a spiral form of a material having a high magnetic permeability.

2. The electromagnet of claim 1, further comprising
disc forms of an electrically conductive material, wherein the disc forms are placed on opposite sides of said electromagnet.

3. The electromagnet of claim 1, wherein an additional electromagnet of said claim is electrically connected, thus enabling an electrical current to travel and flow within the same consistent electrical current direction enabling multiple electromagnets to become electrically connected.

4. The electromagnet of claim 1, wherein a permanent magnet is placed within the center.

5. The electromagnet of claim 1, wherein a LC circuit is connected to the spiral form of the electrically conductive material.

6. The electromagnet of claim 3, wherein a circular array of said electromagnet surrounds a rotor of an electrically conductive material, also having permeant magnets inserted within the rotor slots.

7. The electromagnet of claim 3, wherein it is nested within an additional electromagnet of said claim.

8. The electromagnet of claim 3, wherein it is placed within a structural support base of an electrically conductive material.

9. The electromagnet of claim 3, wherein it is placed within a multi-part enclosure of an electrically conductive material.
